(19) United States
(12) Patent Application Publication
(10) Pub. No.: US 2023/0208082 A1
(43) Pub. Date: Jun. 29, 2023

(54) Electric Assembly Having a Contact Body Comprising or Consisting of an Elastically Flexible and Electrically Conductive Material

(71) Applicant: TE Connectivity Germany GmbH, Bensheim (DE)

(72) Inventors: Guenter Feldmeier, Bensheim (DE); Martin Szelag, Bensheim (DE)

(73) Assignee: TE Connectivity Germany GmbH, Bensheim (DE)

(21) Appl. No.: 18/170,237

(22) Filed: Feb. 16, 2023

Related U.S. Application Data
(63) Continuation of application No. PCT/EP2021/072761, filed on Aug. 16, 2021.

(30) Foreign Application Priority Data
Aug. 19, 2020 (EP) 20191797.8

(51) Int. Cl. H01R 13/6584; H01R 13/66; H01R 13/24; H01R 13/52

(52) U.S. Cl. CPC H01R 13/6584; H01R 13/665; H01R 13/2414; H01R 13/521

(57) ABSTRACT

An electric assembly includes a carrier device having an electrical conductor element and a contact body including an elastically flexible and electrically conductive material. The contact body is connected to the electrical conductor element.

### CROSS-REFERENCE TO RELATED APPLICATIONS

This application is a continuation of PCT International Application No. PCT/EP2021/072761, filed on Aug. 16, 2021, which claims priority under 35 U.S.C. § 119 to European Patent Application No. 20191797.8, filed on Aug. 19, 2020.

### FIELD OF THE INVENTION

The invention relates to an electric assembly.

### BACKGROUND

Electrical assemblies comprise at least one conductor element for contacting a mating contact. Usually the electrical conductor is adapted to be abutted by the mating contact, whereby correct alignment of the mating contact and the electrical conductor must be ensured. Therefore, if an offset in the relative position between electrical conductor and mating contact is too high, e.g. due to high tolerances in the manufacturing of the electric assembly, proper contact cannot be assured. As a consequence, electrical assemblies must be rejected at the manufacturing line. It is desired to have an electrical assembly that allows larger tolerances between the conductor element and the mating contact.

### SUMMARY

An electric assembly includes a carrier device having an electrical conductor element and a contact body including an elastically flexible and electrically conductive material. The contact body is connected to the electrical conductor element.

### BRIEF DESCRIPTION OF THE DRAWINGS

The invention will now be described by way of example with reference to the accompanying Figures, of which:

FIG. 1 shows a schematic perspective view of a first exemplary embodiment of an electric assembly according to the invention;

FIG. 2 shows a schematic detail view of the first exemplary embodiment of the electric assembly shown in FIG. 1 with a mating contact;

FIG. 3 shows a schematic perspective view of a second exemplary embodiment of the electric assembly according to the invention;

FIG. 4 shows a schematic perspective view of the second exemplary embodiment of the electric assembly shown in FIG. 3 with a mating contact;

FIG. 5 shows a schematic perspective view of a third exemplary embodiment of the electric assembly according to the invention;

FIG. 6 shows a schematic perspective view of a fourth exemplary embodiment of the electric assembly according to the invention;

FIG. 7 shows a schematic front view of a sixth exemplary embodiment of the electric assembly in a first position;

FIG. 8 shows a schematic front view of the sixth exemplary embodiment of the electric assembly in an intermediate position; and

FIG. 9 shows a schematic front view of the sixth exemplary embodiment of the electric assembly in a second position.

### DETAILED DESCRIPTION OF THE EMBODIMENTS

In the following, the exemplary embodiments of the electric assembly according to the invention are explained in greater detail with reference to the accompanying drawings.

In the figures, the same reference numerals are used for elements which correspond to one another in terms of their function and/or structure.

According to the description of the various aspects and embodiments, elements shown in the drawings can be omitted if the technical effects of these elements are not needed for a particular application, and vice versa: i.e. elements that are not shown or described with reference to the figures but are otherwise described below can be added if the technical effect of those particular elements is advantageous in a specific application.

In the inventive electric assembly, a contact body is connected to the conductor element. Therefore, the mating contact does not have to directly abut the conductor element. It may contact the conductor element via the contact body. The contact body comprising or consisting of an elastically flexible material may compensate for larger tolerances in the relative position of the conductor element and the mating contact. Hence, fewer electric assemblies will be rejected due to discrepancies between the supposed and actual positions of the conductor element on the carrier.

According to a general aspect, an electric assembly 1 comprises a carrier device 2 having at least one electrical conductor element 4 and comprising at least one contact body 6. The at least one contact body 6 comprises or consists of an elastically flexible and electrically conductive material 8 and is connected to the at least one electrical conductor element 4. In an embodiment, the carrier device 2 may comprise multiple conductor elements 4, wherein the conductor elements 4 may be electrically isolated from one another. A separate contact body 6 may be provided for each conductor element 4.

The at least one contact body 6 may for example comprise or consist of electrically conductive metal threads or carbon nanotubes which may be formed to an elastic mass, e.g. by pressing.

In another embodiment, the at least one contact body 6 may comprise or consist of an electrically conductive elastomer, particularly an elastomeric composite. Such an electrically conductive elastomer composite may comprise an elastomer in which conductive particles are dispersed throughout the raw material prior to setting it. Alternatively, predetermined paths may be provided along which the conductive particles are concentrated within the elastomeric mass. The conductive particles may be concentrated in a section of the contact body 6 such that the contact body 6 may be electrically conductive at said section and electrically isolating apart from said section.

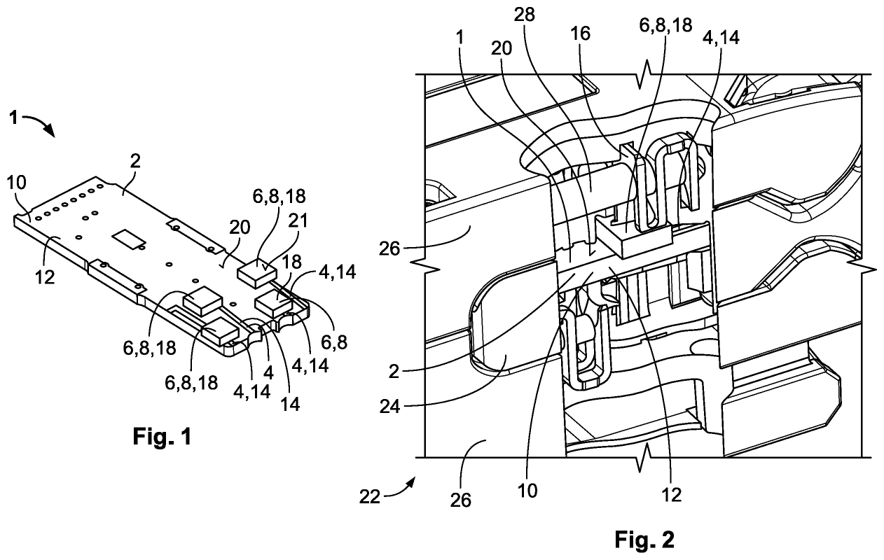

In FIGS. 1 and 2, a first exemplary embodiment of the inventive electric assembly 1 is shown.

According to the first exemplary embodiment, the carrier device 2 may be a circuit board 10, particularly a printed circuit board.

The circuit board 10 comprises a rather rigid plate-shaped structure 12 of insulating material to which integrated circuits, such as conductive tracks 14 are attached. A plurality of separate conductive tracks may be provided electrically isolated from one another by air and/or the insulating material. Each conductive track 14 may form an electrical conductor element 4 which may lead to a different component to be contacted. The exact positioning of the at least one conductive track 14 and the mating contact may be difficult, so that by providing the at least one contact body on the at least one conductive track 14, a higher tolerance in the relative position between the mating contact and the at least one conductive track 14 may be compensated.

In order for a mating contact 16 to easily contact the electrical conductor element 4, the contact body 6 may be disposed onto the electrical conductor element 4 forming a contact pad 18 protruding from a surface 20, particularly a top surface, of the carrier device 2. The contact body 6 being elastically deformable may thus provide a cushioned interface between the mating contact 16 and the electrical conductor element 4. Therefore, the contact body 6 may compensate for tolerances between the mating contact 16 and electrical conductor element 4.

A plurality of separate contact bodies 6 may be provided each forming a contact pad 18 for a separate mating contact 16 for contacting an individual electrical conductor element 4. In this exemplary embodiment, four separate contact bodies 6 are provided, each adapted to contact a different mating contact 16.

The contact body 6 may comprise a larger cross section in a plane essentially parallel to the surface 20 than the part of the electrical conductor element 4 covered by the contact body 6. In other words, the contact body 6 may comprise a larger contacting surface 21 for contacting the mating contact than the electrical conductor element 4. Therefore, the contact body 6 may also serve as an enlarged contacting surface or contact pad for the mating contact 16. In an embodiment, at least one contact body 6 may extend laterally beyond the lateral edge of the carrier device 2.

In an embodiment, the carrier device 2 may be at least partially received in the contact body 6. Thus, the contact body 6 may form a protective shell for the part of the carrier device 2 received in the contact body 6.

Instead of a circuit board as shown in FIGS. 1 and 2, the carrier device 2 may also be just an electrically conductive contact element such as a contact tab or a contact spring.

The contact body 6 may particularly form a seal for the carrier device 2 or at least the electrical conductor element 4. For this, the carrier device 2 or at least the conductor element 4 may be covered by the contact body 6 or even embedded by the contact body 6. Therefore, the electrical conductor element 4 may be prevented from coming into contact with particles like dust and/or liquids.

The contact body 6 may particularly be directly disposed on the electrical conductor element 4. In an embodiment, the contact body 6 may be fixedly attached to the electrical conductor element 4. The contact body 6 may be dispensed or molded to the carrier device 2. The contact body 6 may be formed onto the carrier device 2 with a one-shot injection molding process, a two-shot injection molding process, or a hotmelt molding process. Therefore, the contact body 6 may comprise or consist of a thermosetting elastomeric composition. Alternatively, the at least one contact body 6 may be formed on a carrier, for example a foil, which may be adapted to be mounted to the carrier device 2. The carrier may be adapted to be adhesively attached to the carrier device 2. The contact body 6 may be formed on the carrier, particularly the foil, in a predetermined configuration.

The electric assembly 1 may be mounted in a connector housing 22 as is shown in FIG. 2. In FIG. 2, a detailed section of a cut view is shown.

The connector housing 22 may comprise a base 24 and a cover 26 pivotably attached to said base 24. In order to provide a compact connector having a high contact density, the circuit board 10 may be a double-sided circuit board, such that opposing flat surfaces of the circuit board 10 are each provided with electrical conductor elements 4. Correspondingly, contact bodies 6 may be provided on each surface, i.e. a top and a bottom surface of the double sided circuit board.

Two covers 26 may be provided, each cover being pivotably attached to the base 24. One cover 26 may be adapted to close a top portion of the housing 22 and the other cover 26 may be adapted to close a bottom portion of the housing 22.

The mating contact 16 may be fixedly held by the cover 26, in an embodiment at an inward facing side. In this case, the mating contact 16 may be an insulation displacement contact, which is adapted to clamp a wire 28 between two cutting flanks, whereby the cutting flanks are adapted to cut through the insulation of the wire 28 and contact the wire's inner conductor.

The wire 28 may be inserted into the connector housing 22 through an opening, whereby the wire 28 may be contacted by the mating contact 16 upon pivoting the cover 26 towards the base 24. Upon closing the connector housing 22 by pivoting the cover 26 towards the base 24, the mating contact 16 may be pressed against or even into the contact body 6. The contact body 6 may increase the contact area for the mating contact 16, allowing higher tolerances in the relative position of the mating contact 16 and the electrical conductor element 4. Furthermore, vibrations or the like can be compensated by the elastically deformable contact body 6 increasing the reliability of the connector.

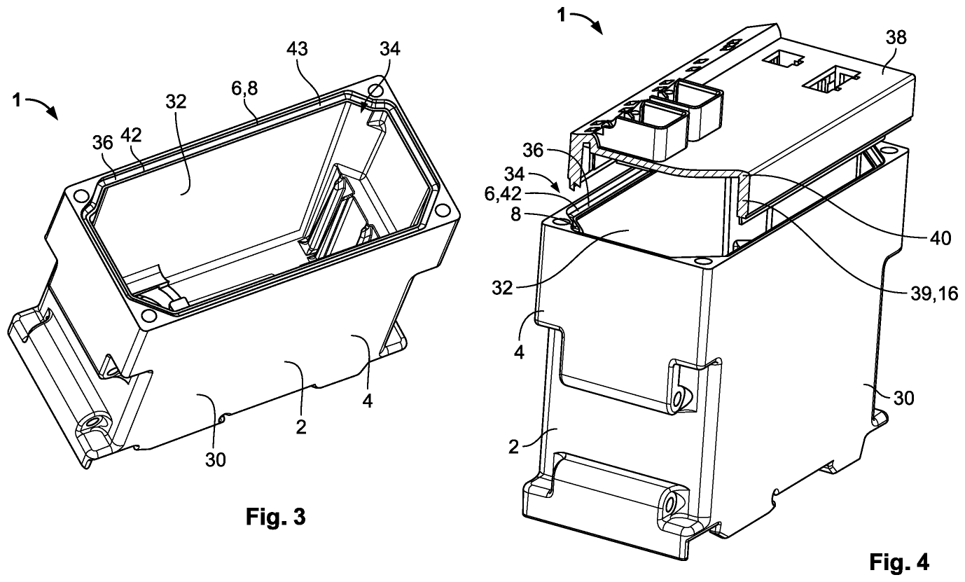

With reference to FIGS. 3 and 4, a second exemplary embodiment of the electric assembly 1 is further elucidated.

In accordance with the second embodiment, the carrier device 2 may be a shielding housing 30 formed as a die cast housing, for example. The shielding housing 30 may comprise or consist of an electrically conductive metal or metal alloy and enclose a receptacle 32, the receptacle 32 being open at a face side 34 of the shielding housing 30.

Circuits or contacts may be inserted into the receptacle through the opening at the face side 34, whereby the circuits or contacts may be prevented from local sources of the local environment from affecting the internal circuits or contacts via electromagnetic interference or vice versa.

The housing 30 may comprise a receiving notch 36 at the face side 34, framing the opening of the receptacle 32.

According to the second embodiment, the electrically conductive shielding housing 30 may constitute the electrical conductor element 4, the receiving notch 36 formed at the face side 34 of the shielding housing 30.

A cover 38, such as a plastic cover, may be provided, the cover being adapted to be mounted to the shielding housing 30 at the face side 34. Hence, the cover 38 may be configured to close the receptacle 32 at the face side 34.

The cover 38 may comprise a metal shielding 39 on a side edge 40 to further increase the electromagnetic compatibility of the contact system.

The contact body 6 may be formed as a sealing gasket 42 protruding from the receiving notch 36. Therefore, the contact body 6 may form an interface for the mating contact 16, i.e. the cover 38, whereby the elastic material is compressed upon mating, sealing the receptacle 32 at least at the face side 34. Thus, liquids or particles such as dust or the like are prevented from entering the receptacle and potentially damaging the internal circuits or contacts.

As the contact body 6 comprises or consists of an electrically conductive material, particularly an elastomeric composite, the contact body 6 may for a shielding 43, providing a continuous path between the shielding housing 30 and the metal shielding 39 of the cover 38. Therefore, the shielding performance of the contact system can be increased as there is no gap between the shielding components improving the electromagnetic compatibility of the electric assembly 1.

The contact body 6 may be formed as a separate interchangeable sealing gasket 42 or may be directly dispensed to the receiving notch 36 via molding or with an extruder device.

When using the contact body 6 for sealing, it may be particularly advantageous if the contact body 6 has a relatively high elasticity. The relatively high elasticity may be defined by a relatively low Young's modulus. In an embodiment, the Young's modulus may not be higher than about 5 GPa. In accordance with an advantageous embodiment, the Young's modulus of the contact body 6 may be between about 0.001 GPa and about 5 GPa.

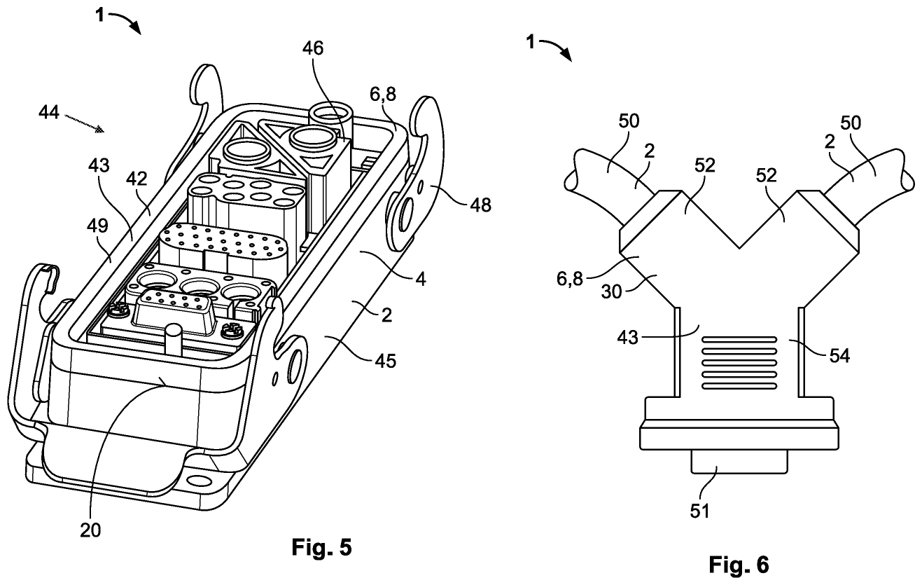

In FIG. 5, a further exemplary embodiment of the inventive electric assembly 1 is shown. As can be seen in FIG. 5, the carrier device 2 may be a shielding housing 30 for improving the electromagnetic compatibility of the contact system, similar to the shielding housing 30 described with reference to the second embodiment.

In this case, however, the shieling housing 30 may be a connector cover 44 adapted to be mounted on a base housing. The connector cover 44 may comprise a frame 45 in which terminal receptacles 46 may be received. The terminal receptacles 46 may receive terminals protruding from the base housing at the face side 34. The connector cover 44 may further comprise a connector interface formed on a side opposite the face side 34 for connecting to a complementary connector.

The connector cover 44 may further comprise locking latches 48 pivotably attached to the frame 45, so that the base housing may be secured to the connector cover 44. The locking latches 48 may also be vertically movable into a lowered position, i.e. away from the base housing, in order to pull the base housing towards the connector cover 44, when the connector cover 44 is mated with the mating housing and secured by the locking latches 48. A sealing gasket 42 may be formed on the face side 34 forming a rim portion 49 for engaging a rim of the base housing. The sealing gasket 42 may particularly form the entire rim portion 49 and may be compressed by base housing upon assembly. The locking latches 48 may pull the base housing towards the sealing gasket 42 providing a constant compression force onto the sealing gasket 42 for sealing the connection between the base housing and the connector cover 44.

The elastically and electrically conductive material of the contact body 6 may particularly be pressure sensitive, so that the electric conductivity of the contact body 6 may be increased upon compression.

The contact body 6 may be configured as a switching and/or safety mechanism, whereby the contact body 5 may comprise macroscopically rather isolating characteristics in a relaxed uncompressed state and whereby the contact body 6 may comprise macroscopically electrically conductive characteristics in a compressed state. This may be implemented by predetermining the density of the conductive particles in the contact body 6, so that the particles are far enough apart in the relaxed uncompressed state. Upon compression, the density of the conductive particles within the contact body 6 may be increased to form a conductive path.

The contact body 6 may particularly be molded to the connector cover 44.

The connector cover 44 may be adapted for heavy duty connectors ensuring safe power transmission even under the harshest conditions. Shielding and sealing functionalities can be integrated in a single component by providing the contact body comprising or consisting of the electrically conductive and elastic material, particularly the elastomeric composite.

A fourth embodiment of the inventive electric assembly 1 is further elucidated with reference to FIG. 6.

The electric assembly 1 comprises a cable 50 forming the carrier device 2. The cable 50 may be a shielded cable having a cable shielding arranged coaxially to a cable core. The cable shielding may shield against electromagnetic interference from the cable core towards the local environment or from the local environment to the cable core. The electric cable 50 may comprise a conductor core, which may act as the conductor element. However, according to an embodiment, the electric cable 50 may be a shielded electric cable, wherein the at least one contact body is connected to the cable shielding.

At least one cable 50 may be terminated to a terminal for connection to a complementary connector. For terminating the cable 50, the cable core is laid bare at a section wherein the cable 50 is to be terminated.

The contact body 6 may be disposed onto the cable shielding continuing the shielding of the cable shielding. The contact body 6 may comprise a sleeve section 52 to be sleeved around the cable shielding contacting the cable shielding and extending coaxially to the cable core, whereby a gap is provided between the cable core and the contact body 6. The cable shielding may thus be embedded in the contact body 6. Hence, according to the fourth exemplary embodiment, the cable shielding forms the electrical conductor element 4. Alternatively, the contact body 6 may be formed as a contact pad, which may be contacted directly by the stripped wire. The stripped wire may also constitute the mating contact adapted to be pressed against the contact body 6 for contacting a different conductor element.

In an embodiment, the contact body 6 may form the entire shielding housing 30 encasing not only the laid bare cable shielding, but also the termination of the cable. The electric assembly may comprise a contact interface 51 mounted in the shielding housing 30 and protruding from the shielding housing 30 at a side distal to an entrance of the cable 50 for connecting with a complementary connector. The complementary connector may comprise a shielding housing, which may serve as the mating contact continuing the shielding from electromagnetic interference to the complementary connector.

The electric assembly 1 may comprise two carriers 2, whose electric conductor may be contacted by a single contact body 6. In this case, two cables 50 may be provided, each being at least partially sleeved by a separate sleeve section 52, whereby the sleeve sections 52 may merge into a central section 54 at which the cables 50 may be terminated.

The contact body 6 may be formed from the conductive elastomeric composite. The composite may comprise an elastomeric base, in an embodiment having good sealing properties. Electrically conductive particles such as graphene, carbon or metals like silver may be dispersed, infused or injected into the elastomeric base. The conductive particles may be dispersed uniformly throughout the contact body 6. Hence, the whole contact body 6 may be electrically conductive. Upon compression of the contact body 6, the density of the conductive particles in the contact body 6 may increase, which may lead to an improvement of the electric conductivity of the contact body 6.

Therefore, the shielding housing 30 may simultaneously be adapted for shielding and sealing the carrier device 2 or the connection with a complementary connector. Furthermore, due to the elastic properties of the contact body 6, tolerances in the relative position of the carrier device 2 relative to the mating contact may easily be compensated.

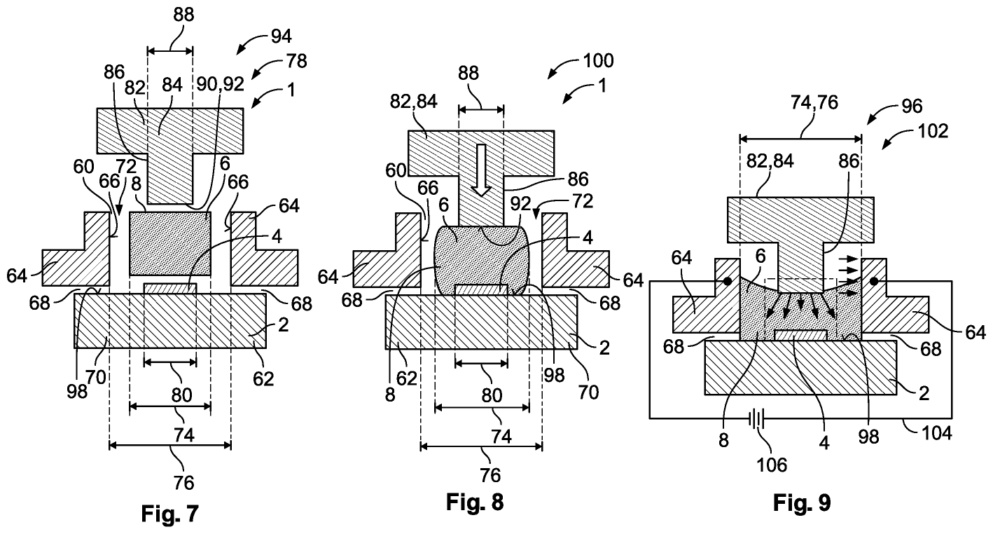

A further advantageous embodiment is described in the following with reference to FIGS. 7 to 9, which show a schematic front view.

The electric assembly 1 comprises a receptacle 60, which may be limited by a bottom wall 62 and lateral walls 64 having lateral surfaces 66. The bottom wall 62 may be spaced apart from the lateral walls 64, such that a gap 68 is formed between the bottom wall 62 and the lateral surfaces 66. The bottom wall 62 may be formed by a substrate 70 such as a circuit board, an electrically conductive component, e.g. a die cast part, or an electrically insulating component. In this exemplary embodiment, the bottom wall 62 is formed by a substrate 70 having a conductor element 4, such as a conductive path or pad, facing the receptacle 60. The conductor element may for example be a grounding contact or the like. In an embodiment, the substrate 70 extends beyond the lateral surfaces 66 in a lateral direction.

The lateral walls 64 may form a guide 72 towards the bottom wall 62. In this exemplary embodiment, the lateral walls 64 may be formed by an electrically conductive material. The lateral walls 64 may for example be part of a shielding, which prevents electromagnetic interference. In a further not shown embodiment, the lateral walls 64 may be electrically insulating or at least one lateral surface may comprise a signal contact, power contact or ground contact.

At least one contact body 6 formed from an electrically conductive and elastically flexible material 8, particularly an electrically conductive elastomer, may be received within the receptacle 60. In FIG. 7, the at least one contact body 6 is shown hovering in the air. This shows that the at least one contact body 6 may be a separate component such as a gasket, which is inserted into the receptacle. However, the at least one contact body 6 may also be rigidly attached, e.g. molded to one of the lateral surfaces or the bottom surface.

In an embodiment, the at least one contact body 6 is arranged within the receptacle 60 having a width 74 in the lateral direction, which is lower than a width 76 of the receptacle 60, at least in a relaxed state 78 as shown in FIG. 7. Hence, the at least one contact body 6 may be distanced from at least one lateral surface. The at least one contact body 6 may, at least in the relaxed state, be arranged equidistantly to each lateral surface 66 and is not elastically deformed. As can be seen in FIG. 7, the width 74 of the at least one contact body 6 may be larger than a width 80 of the conductor element 4 such that the at least one contact body 6 may be adapted to cover the at least one conductor element 4 and protect the at least one conductor element from dust particles and liquids. In the at least relaxed state, a bottom wall 62 of the receptacle 60 may be openly accessible.

An activation element 82 for elastically deforming the at least one contact body 6 may be provided. The activation element 82 may for example be a cover 84 having a protrusion 86 with a width 88 that is lower than the width 76 of the receptacle 60, such that the protrusion 86 may extend into the receptacle 60. In an embodiment, the width 88 of the protrusion 86 may be lower than the width 74 of the at least one contact body 6. A front face 90 of the protrusion 86 forms a press-on surface 92, which is adapted to rest on the at least one contact body 6 and faces towards the bottom wall 62. Advantageously, the protrusion 86, the at least one contact body 6 and the conductor element 4 on the bottom wall 62 may be aligned. The protrusion 86 may essentially be configured to be arranged centrally in the lateral direction in the receptacle 60, such that it is equally distanced from both lateral surfaces 66.

The activation element 82 may be formed from an electrically conducting material. Alternatively, only the press-on surface 92 may be electrically conducting. For example, the press-on surface 92 may be formed by an electrically conducting coating which is applied to the front face of the protrusion. In a further embodiment, the activation element 82 may be electrically insulating.

In FIG. 7, the activation element 82 is shown in a first position 94 in which it does not press against the at least one contact body 6. It is to be noted that as with the lateral surfaces and the bottom surface, the at least one contact body 6 may, in one embodiment, also be rigidly attached to the press-on surface 92, e.g. via molding or the like. The first position 94 denotes a position in which the at least one contact body 6, which may be a gasket, is in a relaxed state.

The activation element 82 may be movable from the first position 94 into a second position 96, which is shown in FIG. 9. The protrusion 86 of the activation element 82 may press the at least one contact element against the bottom wall 62, which thus acts as a counter surface 98. At an intermediate position 100, shown in FIG. 8, the at least one contact body is squeezed between the at least one press-on surface 92 and the counter surface 98 covering the conductor 4 and thus sealing the conductor 4.

The counter surface 98 may be provided with a substrate, a die cast part, an isolating member or the like. In an embodiment, the counter surface 98 is arranged within a housing. The lateral surfaces 66 can be part of the housing. For example, the lateral surfaces 66 can form guiding surfaces guiding the movement of the activation element 82. The lateral surfaces 66 may be formed by shielding contacts, which may be contacted by the contact body 6 in the elastically deformed state. Therefore, an electrical connection for shielding can be established by the at least one contact body 6 in the elastically deformed state.

As the at least one contact body is electrically conductive, an electric path from the activation element 82 to the conductor element 4 is provided. As the conductor element 4 is in this exemplary embodiment, a grounding contact, a grounding connection is established. The at least one contact body 6 may be configured to form an electrically conductive bridge between the press-on surface 92 and the counter surface 98 after the at least one contact body 6 is pressed down about 20% of the way until it reaches the elastically deformed state.

Upon further movement of the activation element 82 towards the bottom wall 62, the material 8 of the at least one contact body 6 is pushed laterally outwards, therefore expanding the width 74 of the at least one contact body 6.

In the second position 96 of the activation element 82, the material 8 has been pushed so far that it is also pressed against the lateral surfaces 66, closing the gaps 68 and completely covering the bottom wall within the receptacle. Thus, the at least one contact body reaches an elastically deformed state 102. As the lateral surfaces 66 are electrically conductive in this exemplary embodiment, electric connections may be established via the at least one contact body 6. The lateral walls 64 may for example be shielding contacts which provide protection against electromagnetic interference. In another embodiment, the lateral surface 66 may be electrically isolating.

In this embodiment, the at least one contact body 6 may have a concave shape formed by the press-on surface 92 in the elastically deformed state 102. Hence, the material of the at least one contact body 6 may be displaced into a space between the press-on surface 92 and the lateral surfaces 66 of the receptacle upon deformation. Therefore, the strain caused by the press-on surface 92 on the at least one contact body 6 may be further reduced.

The electric connection may serve different purposes, such as a signal contact or a power contact. In an embodiment, a ground connection is established. To do this, the press-on surface 92 or the counter surface 98 may form a ground contact. The substrate with the counter surface 98 may for example be a circuit board having conductive paths and/or conductive pads. The activation element 82 may press the at least one contact body 6 against at least one conductive path and/or at least one conductive pad establishing an electric connection. In an embodiment, the at least one contact body 6 may fully cover the at least one conductive path and/or at least one conductive pad sealing said at least one conductive path and/or conductive pad.

In an embodiment, the activation element 82 may be fixed at the second position in which the at least one contact body 6 is in a deformed state, so as to keep a constant pressure on the at least one contact body 6 during use. The activation element 82 may for example be latched, screwed or glued in said position.

According to an embodiment, the lateral walls 64 may be part of an electric circuit that is closed by the at least one contact element 6 in the elastically deformed state 102 as shown in FIG. 9. The electric circuit 104 may be closed by the at least one contact body 6 when the activation element 82 is in the second position 96. An electric signal 106 may be provided to indicate that the activation element 82 has reached the second position 96 and the at least one contact body 6 has reached the elastically deformed state 102. The electric signal may be converted into an acoustic and/or visual signal such that the signal may be easily noticed. Thus, this embodiment may provide a further safety function, indicating to the customer whether the electric assembly is correctly installed or whether the connection is lost during long term use.

Generally, the sixth embodiment shows a multifunctional purpose of the contact body 6. It may simultaneously serve as a shielding contact, a grounding contact, a seal and a signal contact. Depending on the application requirements, different functions of the contact body 6 can be established either in combination with other functions or separately. Different components can form the carrier device while the contact body 6 seals the receptacle 60 and forms an electrically conducting bridge between conductors.

What is claimed is:

1. An electric assembly, comprising:
a carrier device having an electrical conductor element; and
a contact body including an elastically flexible and electrically conductive material, the contact body connected to the electrical conductor element.

2. The electric assembly of claim 1, wherein the elastically flexible and electrically conductive material is an electrically conductive elastomer.

3. The electric assembly of claim 1, wherein the contact body protrudes from a surface of the carrier device.

4. The electric assembly of claim 1, wherein the carrier device is at least partially received in the contact body.

5. The electric assembly of claim 1, wherein the carrier device is at least partially embedded in the contact body.

6. The electric assembly of claim 1, wherein the contact body is formed on a carrier element attached to the carrier device.

7. The electric assembly of claim 1, wherein the contact body is directly formed onto the electrical conductor element.

8. The electric assembly of claim 1, wherein the contact body is fixedly attached to the carrier device.

9. The electric assembly of claim 1, wherein the contact body is molded to the carrier device.

10. The electric assembly of claim 1, further comprising a mating contact, the contact body is an interface between the electrical conductor element and the mating contact.

11. The electric assembly of claim 1, wherein the contact body has a contacting surface larger than a contact surface of the electrical conductor element.

12. The electric assembly of claim 1, wherein the carrier device is one of a circuit board, a stripped wire, an electric cable, and a shielding housing.

13. The electric assembly of claim 1, wherein the contact body is at least one of a sealing gasket, a contact pad, and a shielding.

14. The electric assembly of claim 1, further comprising a receptable having a bottom wall, the contact body is received in the receptable in an elastically deformed state in which the bottom wall is sealed by the contact body.

15. The electric assembly of claim 14, further comprising an activation element having a press-on surface, a width of the press-on surface is less than a width of the receptacle.

16. The electric assembly of claim 14, wherein the receptacle is limited by at least two different components of the electric assembly.

17. The electric assembly of claim 14, wherein an electric signal is activated by an electric bridge formed by the contact body indicating an elastically deformed state of the contact body.

18. The electric assembly of claim 1, wherein the contact body is a seal, a grounding contact, and a shielding contact.

19. A contact body, comprising:
an elastically flexible and electrically conductive material forming a contact interface between a carrier device and a mating contact.

20. A contact body, comprising:
an elastically flexible and electrically conductive material that is a sealing gasket and/or a part of a shielding.
